(19) United States
(12) Patent Application Publication
(10) Pub. No.: US 2017/0301148 A1
(43) Pub. Date: Oct. 19, 2017

(54) METHOD AND SYSTEM OF AUTOMATIC BILLING OF TRANSPORTATION SERVICES

(71) Applicant: Babu Vinod, Fremont, CA (US)

(72) Inventor: Babu Vinod, Fremont, CA (US)

(21) Appl. No.: 15/432,931

(22) Filed: Feb. 15, 2017

Related U.S. Application Data
(60) Provisional application No. 62/295,145, filed on Feb. 15, 2016.

(51) Int. Cl. G07B 13/00; G06Q 20/12; G06Q 30/04; G01S 19/42; H04W 88/02

(52) U.S. Cl. CPC G07B 13/00; G06Q 30/04; G01S 19/42; G06Q 20/12; H04W 88/02

(57) ABSTRACT

In one aspect, a process for automatic billing of transportation services includes the step of generating a first travel vector for a traveler. The process includes the step of generating, a second travel vector for a travel provider. The process includes the step of determining that the traveler's location and movement is synchronized with a travel-service provider within a specified distance threshold. The process includes the step of comparing first travel vector with second travel vector. The process includes the step of determining that the first vector and the second vector are within the specified distance threshold. The process includes the step of measuring the time period that the first vector and the second vector are within the specified distance threshold. The process includes the step of billing the traveler for the time period that the first vector and the second vector are within the specified distance threshold.

### CROSS-REFERENCE TO RELATED APPLICATIONS

This application claims priority to U.S. Provisional Application No. 62/295,145, titled and METHOD AND SYSTEM OF AUTOMATIC BILLING OF TRANSPORTATION SERVICES filed on Feb. 15, 2016. This provisional application is incorporated by reference in its entirety.

### BACKGROUND

### 1. Field

This application relates generally to automated travel services, and more specifically to a system, article of manufacture and method for automatic billing of transportation services.

### 2. Related Art

Travel service providers can charge travelers for using their services to travel. Example travel providers can be ride sharing services, taxis, ferries, buses, airplanes, etc. A user can be required to pay the travel-service provider upon entry into the travel service provider's vehicle. A user can be required to pay the travel-service provider upon exit from the travel service provider's vehicle. In either case, disputes as the cost can arise between the traveler and the travel service provider. Accordingly, improvements to the methods of calculating a traveler's bill for using a travel-service provider are sought.

### BRIEF SUMMARY OF THE INVENTION

In one aspect, a process for automatic billing of transportation services, includes the step of generating a first travel vector for a traveler. The process includes the step of generating a second travel vector for a travel provider. The process includes the step of determining that the traveler's location and movement is synchronized with a travel-service provider within a specified distance threshold. The process includes the step of comparing first travel vector with second travel vector. The process includes the step of determining that the first vector and the second vector are within the specified distance threshold. The process includes the step of measuring the time period that the first vector and the second vector are within the specified distance threshold. The process includes the step of billing the traveler for the time period that the first vector and the second vector are within the specified distance threshold.

### BRIEF DESCRIPTION OF THE DRAWINGS

FIG. 1 illustrates an example system for automatic billing of transportation services, according to so embodiments.

FIG. 2 illustrates an example process for automatic billing of transportation. services, according to some embodiments.

FIG. 3 illustrates another example process for automatic billing of transportation services, according to some embodiments.

FIG. 4 depicts an exemplary computing system that can be configured to perform any one of the processes provided herein.

FIG. 5 is a block diagram of a sample computing environment that can be utilized to implement various embodiments.

FIG. 6 illustrates an example process for automatic of transportation; services, according to some embodiments.

The Figures described above are a representative set, and are not an exhaustive with respect to embodying the invention.

### DESCRIPTION

Disclosed are a system, method, and article of manufacture for automatic billing of transportation services. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth, in other instances, well-known structures, materials, or operations are not shown or described in detail to avoid obscuring aspects of the invention.

The schematic flow chart diagrams included herein, are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### DEFINITIONS

Example definitions for some embodiments are now provided.

Application programming interface (API) can specify how software components of various systems interact with each other.

E-commerce payment system facilitates the acceptance of electronic payment for online transactions.

Global Positioning System (GPS) is a space-based navigation system that provides location and time information.

Geolocation is the identification of the real-world geographic location of an object, such as a mobile device. Geolocation may refer to the practice of assessing the location and/or to an actual assessed location.

Location-based services (BS) are a general class of computer program-level services that use location data to control features. As such LBS is an information service and has a number of uses in social networking today as an entertainment service, which is accessible with mobile devices through the mobile network and which uses information on the geographical position of the mobile device.

Transportation network company (TNC) can connect paying passengers with drivers who provide the transportation on their own non-commercial vehicles. All parties connect to the service via website and mobile applications.

Travel vector can be a representation of a user's travel based on, inter alia: a time variable, a speed variable, an acceleration variable, a set of location variables (e.g., as a series as a function of time, etc.), etc., according to some embodiments. Travel vector can include a Euclidean vector that is a geometric object that has magnitude (e.g. that represents speed, velocity, acceleration, etc.) and direction.

Wi-Fi positioning system (WPS) can use various indoor positioning systems techniques to determine a mobile device's location. For example, WPS can determine a position of a mobile device with wireless access points based on measuring the intensity of the received signal (e.g. received signal strength indication) and/or the, method of fingerprinting. Example parameters useful to geo-locate with WPS include, for example: Wi-Fi hotspot identity and location; wireless access point identity and location (e.g. including the SSID and the MAC address of the access point); etc.

### EXAMPLE SYSTEMS

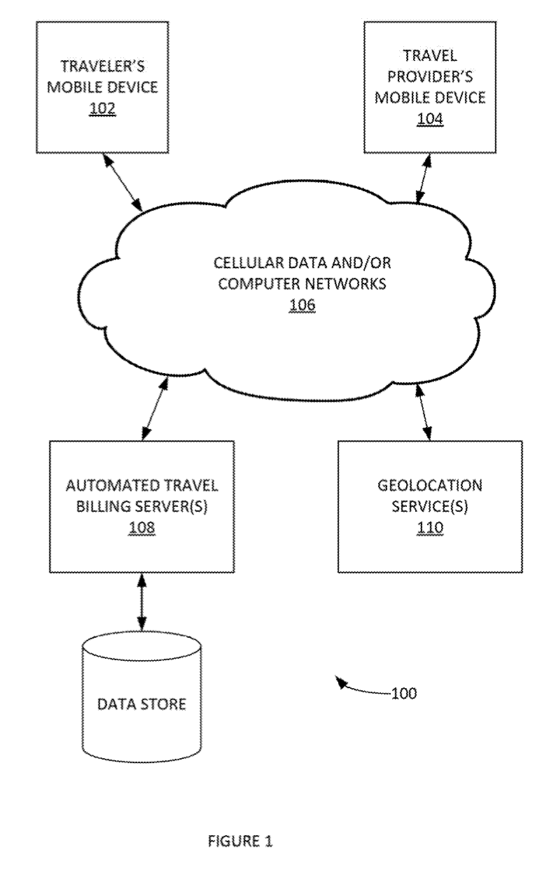

FIG. 1 illustrates an example system 100 for automatic billing of transportation services, according to some embodiments. System 100 can enable automatic billing, of transportation services. For example, a user (e.g. a traveler) can have a mobile device. The mobile device can be used to track the user's location and travel (e.g. a user's movement through various geolocations). In some examples, a user can be a package or object with a mobile device connected to it.

Another user (e.g. a travel provider) can also have a mobile device. The mobile device can be used to track the travel provider's location and travel. Example travel providers can be people that operate vehicles for travel (e.g. a bus driver, a ride-share driver, a taxi driver, an airplane pilot, a boat operator, a train conductor, etc.).

System 100 can detect when a traveler uses a travel provider's vehicle. For example, system 100 can detect that the traveler and the travel provider are in substantially the same location (e.g. within a specified distance threshold for a specified percentage of time, etc.) and/or traveling in the same speed, directions, etc. This can cause system 100 to determine that the traveler is using the travel provider's vehicle. System 100 can automatically bill the traveler for the period that the traveler is traveling with the travel provider.

In one example, a bus driver can have a mobile device with an application that tracks the geolocation of the bus driver. The user can ride the bus. The user can have a mobile device that tracks the user's geolocation. System 100 can determine that the user rode the bus for a certain distance and/or time and bill the user's payment account accordingly. System 100 can use online payments system for said pecuniary transactions.

More specifically, system 100 can include traveler's mobile device 102. Traveler's mobile device 102 can include a geolocation application that geolocates the traveler's geolocation (e.g. on a periodic basis) and communicates said geolocation to automated travel billing server(s) 108 via network(s) 106. Traveler's mobile device 102 can also include information used to verify the travel provider's identity and/or other metadata. The application can also enable a user to interface with system 100 (e.g. via a website, an application user interface, etc.). In this way, a user can verify travel, input billing options, credit card information, etc.

Travel provider's mobile device 104 can include a geolocation application that geolocates the traveler's geolocation (e.g. on a periodic basis) and communicates said geolocation to automated travel billing server(s) 108 via network(s) 106. Travel provider's mobile device 104 can also include information used to verify the travel provider's identity and/or other metadata. The travel provider's application can also include other services for various operations, such as, verifying travel, inputting billing options, credit card information, etc.

Automated travel billing server(s) 108 can track the geolocation of various users (e.g. by receiving geolocation information from user mobile devices, etc.). Automated travel billing server(s) 108 can represent a user's location as a function of time, speed, etc. as a travel profile. Automated travel billing server(s) 108 can generate a travel profile for its users. Travel profiles can be mathematically represented as vectors based on such variables/parameters as geolocation (e.g. in a time series), time, speed, geolocation accuracy information, travel routes, etc. Various mathematical operations can be implemented to determine matches (e.g. based on specified threshold similarities between two or more travel vector values). Automated travel billing server(s) 108 can automatically bill users for travel services. Automated, travel billing server(s) 108 can include other functionalities, such as, inter alia: databases (e.g. a data store), database managers, web servers, calculators, statistics engines, APIs for interaction with third-party systems, user-profile managers, security systems, mapping systems. etc. In some embodiments, third-party systems (e.g. geolocation service(s) 110) can track and/or assist in tracking a user's geolocation. Geolocation service(s) 110 can include various entities (e.g. cell phone service providers, mobile-device application providers, mapping server providers, Wi-Fi service providers, governmental entities, etc.) that also track a user's mobile device location.

In some embodiments, a fee can be determined based on a distance a user traveled, In other cases, the fee can be determined based on time the user was in a travel vehicle (e.g. automobile, bus, boat, airplane, train, other mass transit systems, etc.). In some examples, ride-sharing factors can be calculated into the user's final bill. For example, users be in a ‘ride share’ mode. System 100 can detect that two or more users are in a vehicle and automatically split the bill based on the number of ‘ride share’ mode users in the vehicle. System 100 can implement the following processes and methods provide infra. System 100 and the processes provided infra can be integrated with mobile ride request company's services (e.g. as a billing method of an Uber® ride, etc.).

### EXAMPLE METHODS

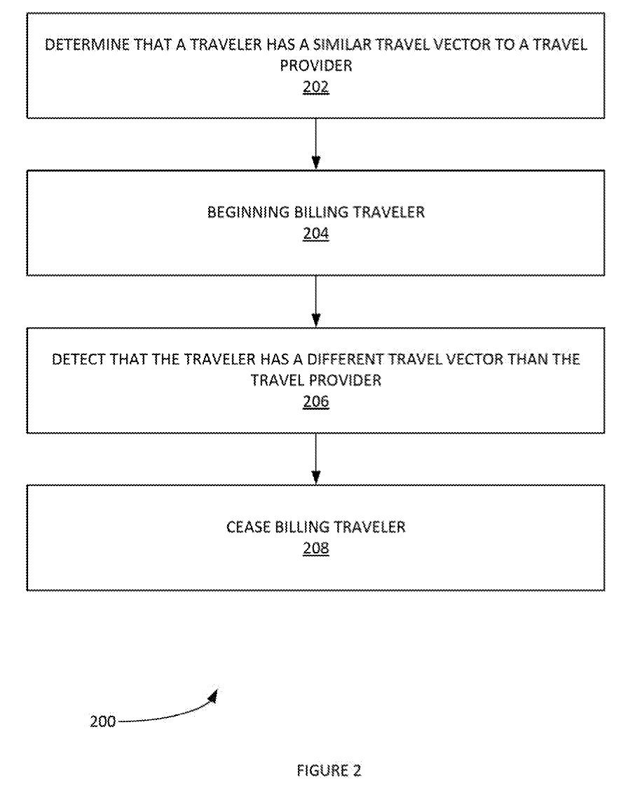

FIG. 2 illustrates example process 200 for automatic billing of transportation services, according to some embodiments. In step 202, process 200 can determine that traveler has a similar travel vector to a travel provider. For example, process 200 can determine that the traveler's location and movement is synchronized with a travel-service provider and/or a travel-service provider's vehicle. Locations can be determined by tracking a GPS signal at specified periods and extrapolating a position and movement from said GPS signal. The GPS signal can be associated with mobile device of the travel, travel provider, etc. GPS signals and/or data about the GPS signals can be obtained by a server that implements process 200. In step 204, process 200 can begin billing traveler (e.g. calculating an amount due from the traveler at specified intervals and/or distances and/or preset locations). It is noted that a final bill can be submitted to an online billing service or other electronic payment entity after the traveler has stopped using the travel-provider's service in step 206, process 200 can detect that the traveler has a different travel vector than the travel provider. In step 208, process 200 can cease billing traveler. Process 200 can provide a metering process for user's obtaining rides on various means of transportation. Process 200 does not require additional hardware computing systems beyond the mobile devices of the users and the server computing system that implements process 200.

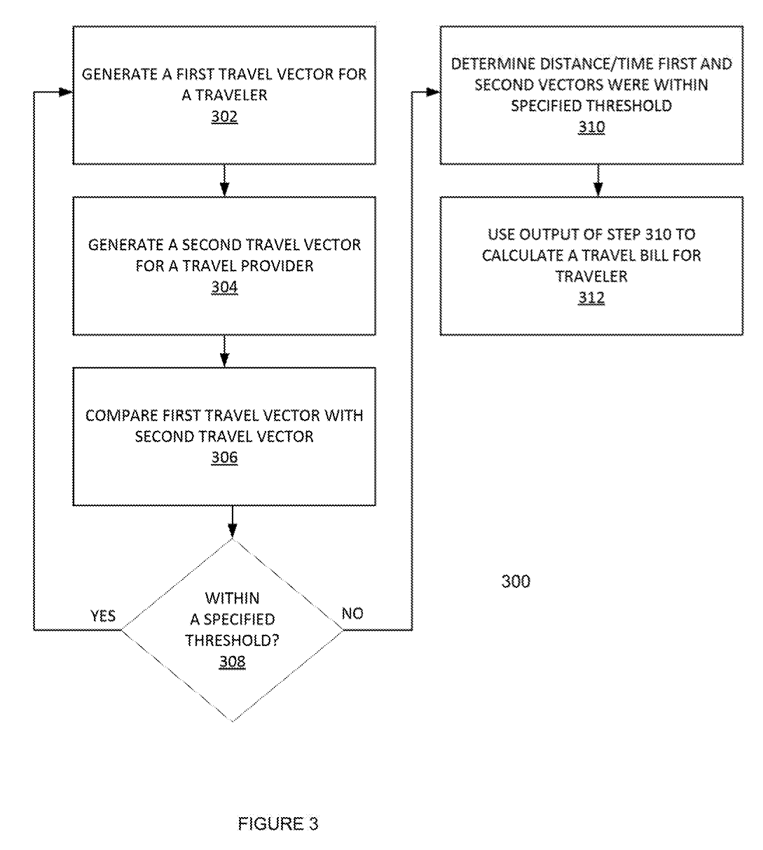

FIG. 3 illustrates another example process 300 for automatic billing of transportation services, according to some embodiments. In step 302, process 300 can generate a first travel vector for a traveler. A travel vector can be a mathematical representation of various travel attributes such as, inter alia: speed of travel, direction of travel, change of speed in a location, etc. In step 304, process 300 can generate a second travel vector for a travel provider. In step 306, process 300 can compare first travel vector with second travel vector. Various methods of determine a distance between two vectors and/or similarity measures between two vectors can be used in step 308, process 300 can determine if the difference between the first travel vector and the second travel vector are within a specified threshold. For example, a bus driver's travel vector and a rider's travel vector need not exactly matches. A buffer can be given such that slight differences can be taken into account. In this way, a small variation based on geolocation service error and the like can be taken into account and not proceed to step 312 prematurely. In step 310, process 300 can determine distance/time first and second vectors were within specified threshold. If no, then in step 312, process 300 can use output of step 310 to calculate a travel bill for traveler. if yes, then process 300 can return to step 302. In repeating process 300, process 300 need not generate the travel vectors anew. Rather, process 300 can update the travel vectors on a periodic basis.

### ADDITIONAL EXEMPLARY COMPUTER ARCHITECTURE AND SYSTEMS

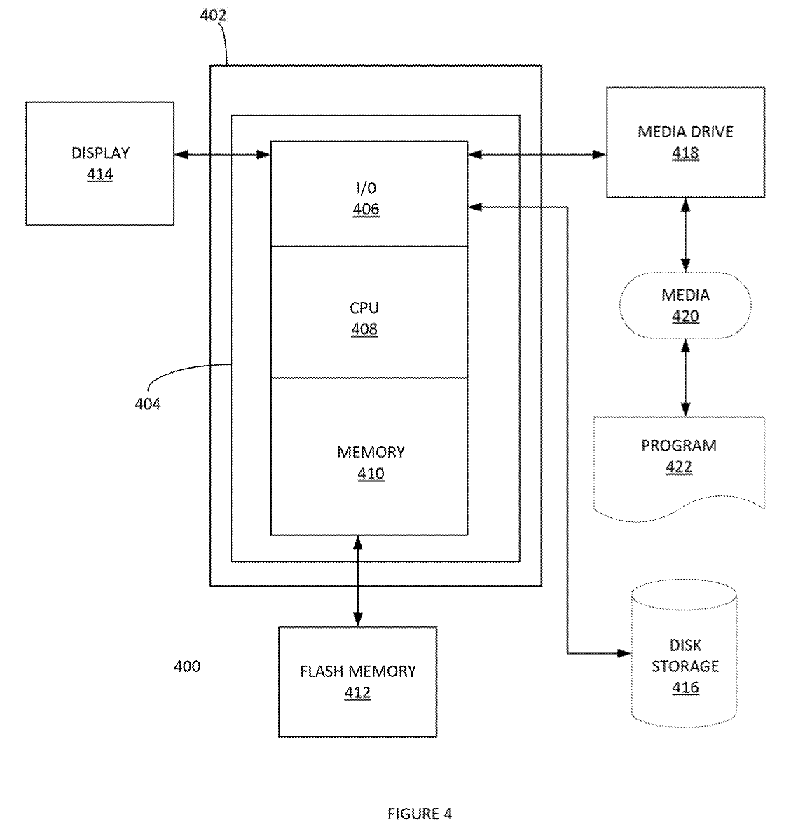

FIG. 4 depicts an exemplary computing system 400 that can be configured to perform any one of the processes provided herein. In this context, computing system 400 may include, for example, a processor, memory, storage, and I/O devices (e.g., monitor, keyboard, disk drive Internet connection, etc.). However, computing system 400 may include circuitry or other specialized hardware for carrying out some or all aspects of the processes. In some operational settings, computing system 400 may be configured as a system that includes one or more units, each of which is configured to carry out some aspects of the processes either in software, hardware, or some combination thereof.

FIG. 4 depicts computing system 400 with a number of components that may be used to perform any of the processes described herein. The main system 402 includes a motherboard 404 having an I/O section 406, one or more central processing units (CPU) 408, and a memory section 410, which may have a flash memory card 412 related to it. The I/O section 406 can be connected to a display 414, a keyboard and/or other user input (not shown), a disk storage unit 416, and a media drive unit 418. The media drive unit 418 can read/write a computer-readable medium 420, which can contain programs 422 and/or data. Computing system 400 can include a web browser. Moreover, it is noted that computing system 400 can be configured to include additional systems in order to fulfill various functionalities. Computing system 400 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

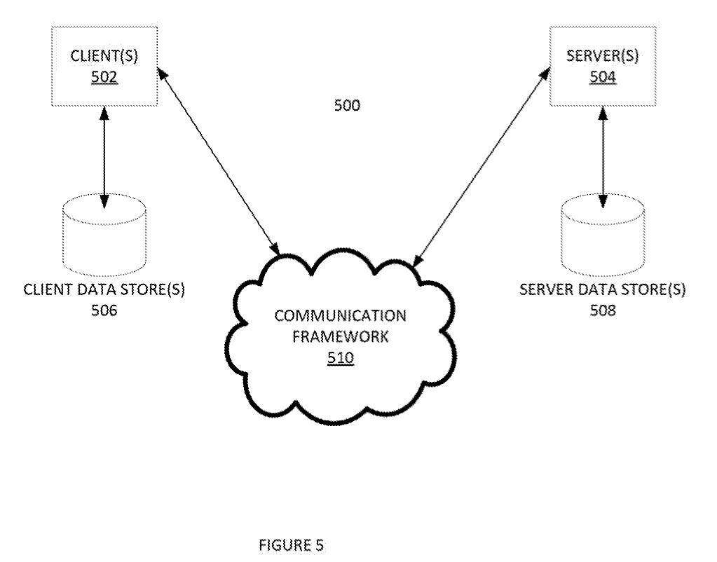

FIG. 5 is a block diagram of a sample-computing environment 500 that can be utilized to implement various embodiments. The system 500 further illustrates a system that includes one or more client(s) 502. The client(s) 502 can be hardware and/or software (e.g., threads, processes, computing devices). The system 500 also includes one or more server(s) 504. The server(s) 504 can also be hardware and/or software (e.g. threads, processes, computing devices). One possible communication between a client 502 and a server 504 may be in the form of a data-packet adapted to be transmitted between two or more computer processes. The system 500 includes a communication framework 510 that can be employed to facilitate communications between the client(s) 502 and the server(s) 504. The client(s) 502 are connected to one or more client data store(s) 506 that can be employed to store information local to the client(s) 502. Similarly, the server(s) 504 are connected to one or more server data store(s) 508 that can, be employed to store information local to the server(s) 504. In some embodiments, system 500 can instead be a collection of remote computing services constituting a cloud-computing platform.

### ADDITIONAL EXEMPLARY METHODS

In one example, system 100 and processes 200-300 can utilized a pricing method similar to that of metered taxis. However, the payment can be handled through a mobile-device application and not with the driver personally. In some examples, when a travel provider's vehicle is travelling at a speed greater than a specified speed (e.g. 11 mph (18 km/h), etc.), the price is calculated on a distance basis; otherwise, the price can be calculated on a time basis. At the end of a ride, the complete fare is automatically billed to the customer's credit card. An automated algorithm can increase prices based on factors as, inter alia: time of day, availability of travel provider(s), local events, etc. system 100 and processes 200-300 can send the traveler's mobile-device application a notice when making a travel-related. It is noted that various payments and money transfers to be made through the Internet. Online money transfers can serve as electronic alternatives to paying with traditional paper methods, such as checks and money orders.

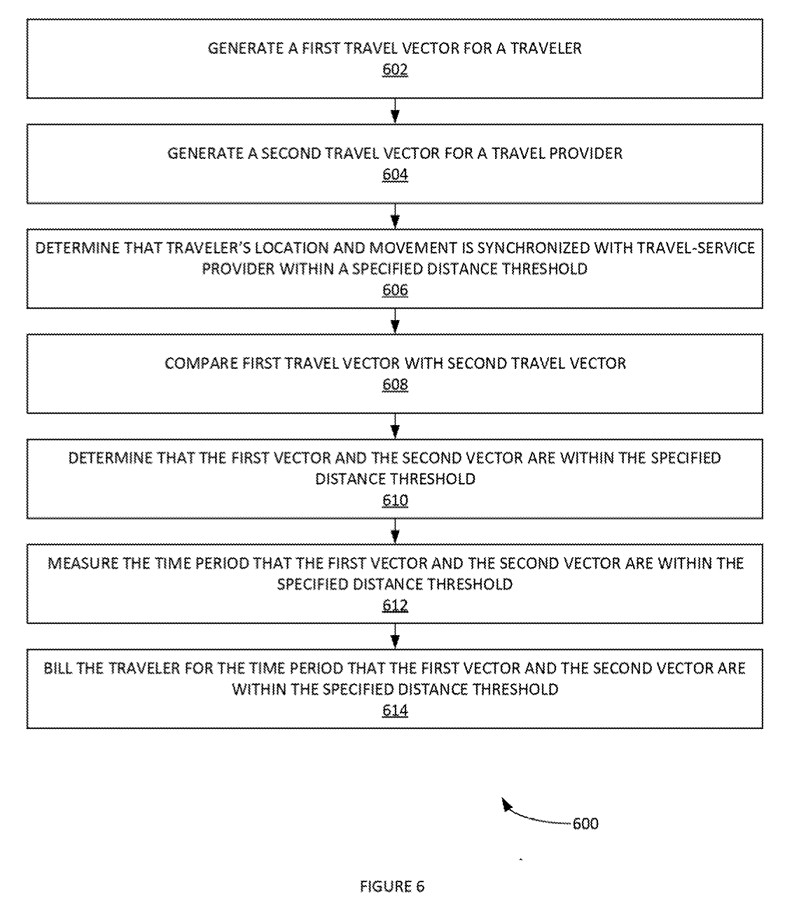

FIG. 6 illustrates an example process 600 for automatic billing of transportation services, according to some embodiments. In step 602, process 600 can generate a first travel vector for a traveler. In step 604, process 600 can generate a second travel vector for a travel provider. In step 606, process 600 can determine that the traveler's location and movement is synchronized with a travel-service provider within a specified distance threshold. In step 608, process 600 can compare first travel vector with second travel vector. In step 610, process 600 can determine that the first vector and the second vector are within the specified distance threshold. In step 612, process 600 can measure the time period that the first vector and the second vector are within the specified distance threshold. In step 614, process 600 can bill the traveler for the time period, that the first vector and the second vector are within the specified distance threshold.

### CONCLUSION

Although the present embodiments have been described with reference to specific example embodiments, various modifications and changes can be made to these embodiments without departing from the broader spirit and scope of the, various embodiments, For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to protected by Letters Patent of the United States is:

1. A computerized method for automatic billing of transportation services comprising:
determining that a traveler has a similar travel vector to a travel provider;
initiating an accounting of a travel bill for the travel;
detecting that the traveler has a different travel vector than the travel provide and terminating the accounting of the travel bill.

2. The computerized method of claim 1, further comprising:
billing the traveler.

3. The computerized method of claim 2, wherein the traveler is billed utilizing an e-commerce payment system.

4. A computerized method for automatic billing of transportation services comprising:
generating a first travel vector for a traveler;
generating a second travel vector a travel provider;
determining that the traveler's location and movement is synchronized with a travel service provider within a specified distance threshold;
compare first travel vector with second travel vector;
determining that the first vector and the second vector are within the specified distance threshold;
measuring the time period that the first vector and the second vector are within the specified distance threshold; and
billing the traveler for the time period that the first vector and the second vector are within the specified distance threshold.

5. The computerized method of claim 4, wherein the step of generating the first travel vector for the traveler further comprises:
tracking a location of a mobile device of the traveler.

6. The computerized method of claim 5, wherein the step of tracking a location of a mobile device of the traveler further comprises:
obtaining a series of Global Positioning System (GPS) location information for the mobile device of the traveler, and wherein the series of Global Positioning System (GPS) location information for the mobile device of the traveler is included in the first travel vector.

7. The computerized method of claim 4, wherein the step of generating a second travel vector for the travel provider further comprises:
obtaining another series of Global Positioning System (GPS) location information for the mobile device of the traveler provider, and wherein the series of Global Positioning System (GPS) location information for the mobile device of the travel provider is included in the second travel vector.

8. The computerized method of claim 4, wherein the specified distance threshold comprises specific constant distance between the traveler and the travel provider for a measured period of time.

9. The computerized method of claim 8, wherein the step of compare first travel vector with second travel vector further comprises:
determining that the traveler and the travel provider are within the specific constant distance for the measured period of time.

10. The computerized method of claim 4, wherein the specific constant distance between the traveler and the travel provider comprises a range of zero feet to ten feet.

11. The computerized method of claim 4, wherein the travel provider comprises a bus. The computerized method of claim 4, wherein the travel provider comprises a ride-sharing service of an online transportation network.

13. The computerized method of claim 4, wherein the mobile device of the user includes an application that:
periodically communicates the location of the mobile device to an automatic billing of transportation services server; and
manages payments for the traveler with respect to an e-commerce payment system.
